(19) United States
(12) Patent Application Publication
(10) Pub. No.: US 2021/0293181 A1
(43) Pub. Date: Sep. 23, 2021

(54) A SYSTEM AND A METHOD FOR POWER GENERATION

(71) Applicant: Rajeev HIREMATH, Karnataka (IN)

(72) Inventor: Rajeev HIREMATH, Karnataka (IN)

(21) Appl. No.: 16/323,315

(22) PCT Filed: Apr. 28, 2018
(86) PCT No.: PCT/IB2018/052960

§ 371 Date: Feb. 5, 2019

(30) Foreign Application Priority Data
Jun. 27, 2017 (IN) 201741022338

(51) Int. Cl. F02C 7/224; F02C 9/26

(52) U.S. Cl. CPC F02C 7/224; F05D 2220/30; F02C 9/26

(57) ABSTRACT

The present application describes a system for power generation includes a combustion chamber connected upstream of a turbine unit inlet of a turbine unit, a turbine unit outlet of the turbine unit connected upstream of the combustion chamber and a pre-heater, the combustion chamber, the turbine unit inlet and the turbine unit outlet forming a closed loop for a working fluid to operate in and a regulator connected within the closed loop.

### TECHNICAL FIELD

Embodiments of the present invention relate to power generation that may be used to power electrical power plants, automobiles, pumps and compressors etc., and more particularly to a system and a method for power generation which offer significant improvements in net output, reduce footprint and improves overall efficiency and reduces emissions.

### BACKGROUND ART

Change of state of energy has always been a physical process on which most of the equipment's or process technologies are based upon. Rotational energy is one form of energy generated by firing fossil fuel to generate electrical power, automobile movement, or to run any other application in industry where rotational movement is required.

Internal combustion machines; turbine units and reciprocating engines are operated based on thermodynamic cycles like Brayton Cycle and Otto Cycle respectively to generate rotational energy. Similarly, steam turbine unit is operated based on the Rankine Cycle to generate rotational energy. Some of the commercial and industrial appliances are operated on electricity to generate rotational movement by use of induction motor e.g. electric driven rail locomotives, battery operated vehicles, pumps, compressors, mixers, etc.

Internal Combustion (IC) Engines used for power generation are of two types: reciprocating engines and direct fired turbine units. IC engines are working in four steps: compression, combustion, expansion and exhaust. The combustion step occurs inside constant volume and constant pressure in reciprocating engines and turbine unit engines respectively which is a basic difference in the operation of both engines. Both engines have limited efficiency by its fundamental principle of Otto Cycle and Brayton Cycle respectively. These cycles utilize compressors which consumes vast amounts of energy. IC engines are called as open cycle systems because they take fresh air & fuel as input to the IC Engine and exhaust of it is always taken out of cycle. The quantum of heat at exhaust outlet is always higher in IC engines than useful output of the IC engines in terms of power, which is limiting engine efficiency. One way of reducing the heat loss to exhaust is to use a combined cycle, however even in case of combined cycle; the heat losses to exhaust remain significant. Further, the IC engines also include losses due to friction, cooling and pumping. Also, the IC engines are greatly dependent on liquid and gaseous fuels and are not capable of combusting solid fuels.

Converting heat energy to rotational energy and subsequently to electrical energy is quite common which are exemplified by existing power generating system where entire principle is based on the Brayton Cycle, Carnot Cycle, Otto Cycle, Rankine Cycle, Cheng Cycle and Kalina Cycle etc. and its further developments including the supercritical CO₂ cycle. Although the above mentioned prior arts aim to provide efficient power generation systems, they still suffer from a number of disadvantages, viz:
1. All fuel firing equipment which generates rotational energy has limited efficiency by fundamental principal of a heat engine.
2. Since many of the present systems operate in open cycle arrangement significant amounts of energy is lost as exhaust heat.
3. Further, for recovery of the exhaust heat, heat recovery mechanisms are required, which leads in higher Capital Expenditure (CAPEX).
4. The present systems have many supporting sub-systems like cooling arrangement in case of IC engines, heat recovery arrangement in case of gas turbine units etc. which requires large footprint.
5. The present systems for power generation require substantial time for system stabilization during start-up condition.
6. Many of the systems including gas turbine units, combined cycles and IC engines are operated on selected liquid or gases fuels which are costlier than other type of fuels hence these systems experiences higher Operational Expenditure (OPEX).
7. Limited efficiency leads to higher fossil fuel consumption and increasing proportionate harmful emissions
8. Proper care of all supporting subsystems needs to be taken to keep running main system which increased maintenance cost, especially in case of the gas turbine units.
9. Power is generated at alternator level which needs to be sent for step-up or step-down system to match grid level.
10. The need for compressor to produce a high mass flow of air increases both the OPEX and CAPEX cost.
11. The need for high pressure in the steam cycles increases operating costs and also requires highly complex and expensive boilers.
12. I.C engines used for propulsion in automotive sector are highly inefficient due to various factors like high level of pollutants produced in the emissions.
   a. Further, there is a need to combust at high frequency, which leads to incomplete combustion and soot formation.
   b. Energy conversion into wasteful forms like heat, vibration and sound is at very high levels.
   c. Need for highly purified forms of fuel.
   d. Limitations in adaptability for using different forms of fuel.
13. Current systems being used to drive pumps and compressors either use high pressure steam or gas turbines connected to drive shafts of the pumps and compressors or a piston type IC engine is coupled. These systems suffer from the above-mentioned inefficiencies.

In light of the discussion above, there is a need in the art for a system and a method for power generation, for automotive power, rotary power and other applications, which do not suffer from above mentioned deficiencies.

### SUMMARY OF THE INVENTION

The present invention is described hereinafter by various embodiments. This invention may, however, be embodied in many different forms and should not be construed as limited to the embodiment set forth herein. Rather, the embodiment is provided so that this disclosure will be thorough and complete and will fully convey the scope of the invention to those skilled in the art.

Embodiments of the present invention aim to provide a system and a method for power generation, for automotive power, rotary power, electricity generation and other applications.

According to a first aspect of the present invention, there is provided a system for power generation, the system comprises a combustion chamber connected upstream of a turbine unit inlet of a turbine unit, a turbine unit outlet of the turbine unit connected upstream of the combustion chamber and a pre-heater the combustion chamber the turbine unit inlet and the turbine unit outlet forming a closed loop for a working fluid to operate in, and a regulator connected within the closed loop. The combustion chamber is configured to receive one or more of air and a fuel from a pre-heater and combust the fuel to generate heat energy in form of flue gases. The regulator is configured to receive a pressure enhancing fluid, from an external source, a mixture of the pressure enhancing fluid and the flue gases generated due to combustion, constituting the working fluid, such that, the pressure enhancing fluid receives heat energy from the flue gases to vaporize in a confined space, thereby increasing density and pressure of the working fluid. The turbine unit is configured to generate mechanical power on expansion of the working fluid and discharge the working fluid out of the turbine unit outlet after the expansion of the working fluid. Also, the combustion chamber and the pre-heater are configured to receive the working fluid from the turbine unit outlet.

In accordance with an embodiment of the present invention, the fuel is one or more of a gaseous fuel, a liquid fuel, a semi-solid fuel and a solid fuel.

In accordance with an embodiment of the present invention, the regulator is configured to receive the pressure enhancing fluid in pre-heated state and liquid phase.

In accordance with an embodiment of the present invention, the system further comprises a speed sensor configured to sense a speed of a Power Take-Off PTO shaft of the turbine unit and communicate the speed to a control device configured to control intermittent firing in the combustion chamber in correlation with the speed.

In accordance with an embodiment of the present invention, wherein an energy storage system of the turbine unit is configured to supply power during non-operation of the combustion chamber.

In accordance with an embodiment of the present invention, the regulator is further configured to regulate pressure, temperature, velocity and mass flow rate of the working fluid.

In accordance with an embodiment of the present invention, the system further comprises a reservoir downstream of the turbine unit wherein the reservoir is configured to receive the working fluid from the closed loop and release excess working fluid to the atmosphere.

In accordance with an embodiment of the present invention, the system further comprises an external heater connected along the closed loop, wherein the external heater is configured to heat the working fluid using a heat exchanger, the heating of the working fluid in the heat exchanger being achieved through flue gases generated by an external combuster.

In accordance with an embodiment of the present invention, piping and equipment used in formation of the closed loop is insulated to prevent heat transfer and the piping and the equipment also include cooling systems to maintain operating temperatures.

In accordance with an embodiment of the present invention, the system further comprises an energy storage mechanism the energy storage mechanism including a flywheel connected to a power take-off shaft of the turbine unit.

In accordance with an embodiment of the present invention, the energy storage mechanism is adapted to store mechanical energy during operation of the turbine unit.

In accordance with an embodiment of the present invention, the system further comprises a second combustion chamber at the turbine unit outlet the second combustion chamber configured to enhance velocity of the working fluid going out of the turbine unit outlet.

In accordance with an embodiment of the present invention, the system further comprises one or more boosters along the closed loop, the one or more booster configured to enhance pressure, velocity and temperature of the working fluid.

In accordance with an embodiment of the present invention, the combustion chamber further comprises a plurality of pulse combustors.

In accordance with an embodiment of the present invention, each one of the plurality of pulse combustors comprises a hydraulic piston mechanism wherein a piston of the hydraulic piston mechanism is adapted to push the flue gases into a working fluid flow in order to increase the temperature and the pressure of the working fluid flow.

According to a second aspect of the present invention, there is provided a pulse combustor comprising a hydraulic piston mechanism wherein a piston of the hydraulic piston mechanism is adapted to push the flue gases into a working fluid flow in order to increase the temperature and the pressure of the working fluid flow.

According to a third aspect of the present invention, there is provided a method for power generation, the method comprising steps of receiving one or more of air and a fuel from a pre-heater in a combustion chamber, combusting the fuel to generate heat energy in form of flue gases, receiving a pressure enhancing fluid, from an external source, in a regulator, a mixture of the pressure enhancing fluid and the flue gases generated due to combustion, constituting a working fluid, receiving heat energy by the pressure enhancing fluid from the flue gases to vaporize in a confined space, thereby increasing density and pressure of the working fluid, generating mechanical power on expansion of the working fluid and discharging the working fluid out of a turbine unit outlet after the expansion of the working fluid, by a turbine unit and receiving the working fluid from the turbine unit outlet in one or more of the combustion chamber and the pre-heater.

In accordance with an embodiment of the present invention, the temperature of the working fluid is more than 200° C.

In accordance with an embodiment of the present invention, the regulator receives the pressure enhancing fluid in pre-heated state and liquid phase.

In accordance with an embodiment of the present invention, the method further comprises a step of sensing a speed of a Power Take-Off PTO shaft of the turbine unit and communicating the speed to a control device to control intermittent firing in the combustion chamber in correlation with the speed.

In accordance with an embodiment of the present invention, the method further comprises a step of supplying, by an energy storage system of the turbine unit power to an alternator or a generator connected with a Power Take-Off PTO shaft of the turbine unit through power electronics systems, during non-operation of the combustion chamber.

In accordance with an embodiment of the present invention, the regulator further regulates pressure, temperature, velocity and mass flow rate of the working fluid.

In accordance with an embodiment of the present invention, the method further comprises a step of receiving the working fluid from the closed loop and releasing excess working fluid to the atmosphere, by a reservoir downstream of the turbine unit.

In accordance with an embodiment of the present invention, the method further comprises a step of heating the working fluid using a heat exchanger of an external heater connected along the closed loop, the heating of the working fluid in the heat exchanger being achieved through flue gases generated by an external combuster.

In accordance with an embodiment of the present invention, the method further comprises a step of storing mechanical energy during operation of the turbine unit by an energy storage mechanism.

In accordance with an embodiment of the present invention, the method further comprises a step of enhancing velocity of the working fluid going out of the turbine unit outlet, by a second combustion chamber at the turbine unit outlet.

In accordance with an embodiment of the present invention, the method further comprises a step of enhancing pressure, velocity and temperature of the working fluid, by one or more boosters along the closed loop.

In accordance with an embodiment of the present invention, the method further comprises a step of pushing the flue gases into a working fluid flow to increase the temperature and the pressure of the working fluid flow, by a hydraulic piston mechanism of plurality of pulse combustors.

The system and the method for power generation offer a number of advantages, viz.

### Basic Cycle

1. Heat and mass of circulating fluid of cycle is recycled in the present invention to minimise the energy loss.
2. Various types of fossil fuel and bio fuel with any form (Gas, Liquid, solid and Semi-solid) based design are possible. Designs of the invention with any combination of fuels are also possible.
3. Operating temperature of the working fluid is ranging from 250° C. to 1250° C. This can be much higher depending on the material constrains and application area.
4. Compressor less technology with inbuilt mass flow and velocity enhancers which will eliminate need for compressors (in case of gas turbine units) or pressurized boilers (in case of steam turbine units).
5. Mass flow and velocity can be increased to minimise wind-age losses and permit higher turndown ratios which may eliminate need for speed governors or speed control devices.
6. Energy consuming utility sub-systems reduce drastically which results in low operating cost and require lesser footprint for this invention.
7. Lesser control systems required.

### Combustion of Fuels

8. Design of combustion chamber can be based on use of Ambient Air, Pure Oxygen or Oxygen Enriched Air to carry out oxidation of fuel.
9. Full load stable operations can be achieved relatively quickly after every start-up and easy to shut down system.
10. Part load can be managed with proportionate reduction in the fuel consumption.

### Turbine Units

11. Velocity and mass flow of circulating fluid is controllable automatically on real time basis to get optimum output as per the demand.
12. Variable RPM can be generated as per demand/requirement.

### Electricity Generation

13. Intermittent firing for variable high-speed rotating turbine units used for electricity generation.
14. This invention is suitable for electricity generation from 10 kW to utility scale models.
15. The invention is compatible for PLC based operation and offsite monitoring and troubleshooting.
16. Design of the invention along with alternator is possible to generate required quality and quantity of power without time lag. Step-up or step-down mechanism is not required in this technology which helps to eliminate related losses.
17. Required speed for alternator or power electronics to generate electricity can be achieved with this technology.
18. Variable high-speed turbine unit electricity generator, propulsion and rotary power generation.
19. Energy bank in the form of flywheel attachments directly coupled with alternator or power electronics.

### BRIEF DESCRIPTION OF THE ACCOMPANYING DRAWINGS

So that the manner in which the above recited features of the present invention can be understood in detail, a more particular description of the invention, briefly summarized above, may have been referred by examples, some of which are illustrated in the appended drawings. It is to be noted, however, that the appended drawing illustrates only typical examples of this invention and are therefore not to be considered limiting of its scope, for the invention may admit to other equally effective examples.

These and other features, benefits, and advantages of the present invention will become apparent by reference to the following text figure, with like reference numbers referring to like structures across the views, wherein:

FIG. 5A illustrates a system for power generation in accordance with an embodiment of the present invention;

FIG. 5B illustrates a turbine unit in accordance with an embodiment of the present invention;

FIG. 7 illustrates a method for power generation in accordance with an embodiment of the present invention;

FIG. 8A illustrates a combustion chamber in accordance with an embodiment of the present invention;

FIG. 8B illustrates a pulse combuster in accordance with an embodiment of the present invention;

FIG. 9 illustrates an implementation of the present invention for external combustion and indirect heat application;

FIG. 10 illustrates implementation of the system for power generation in place of gas turbine units for electrical power generation, in accordance with an embodiment of the present invention;

FIG. 11 illustrates implementation of the system for power generation in place of diesel engines for electrical power generation, in accordance with an embodiment of the present invention;

FIG. 12 illustrates implementation of the system for power generation in place of steam turbine units for electrical power generation, in accordance with an embodiment of the present invention;

FIG. 13A illustrates implementation of the system for power generation in place of diesel engines for propulsion of locomotives, in accordance with an embodiment of the present invention;

FIG. 13B illustrates implementation of the system for power generation in place of diesel engines for propulsion of locomotives, in accordance with another embodiment of the present invention;

FIG. 14 illustrates implementation of the system for power generation in place of diesel engines for propulsion of marine vessels, in accordance with an embodiment of the present invention;

FIG. 15 illustrates implementation of the system for power generation in place of diesel engines in off-road vehicles, in accordance with an embodiment of the present invention; and

FIG. 16 illustrates implementation of the system for power generation in place of electrical motors for operation of industrial equipment, in accordance with an embodiment of the present invention.

### DETAILED DESCRIPTION OF THE PREFERRED EMBODIMENTS

While the present invention is described herein by way of example using embodiments and illustrative drawings, those skilled in the art will recognize that the invention is not limited to the embodiments of drawing or drawings described and are not intended to represent the scale of the various components. Further, some components that may form a part of the invention may not be illustrated in certain figures, for ease of illustration, and such omissions do not limit the embodiments outlined in any way. It should be understood that the drawings and detailed description thereto are not intended to limit the invention to the particular form disclosed, but on the contrary, the invention is to cover all modifications, equivalents, and alternatives falling within the scope of the present invention as defined by the appended claim. As used throughout this description, the word “may” is used in a permissive sense (i.e. meaning having the potential to), rather than the mandatory sense, (i.e. meaning must). Further, the words “a” or “an” mean “at least one” and the word “plurality” means “one or more” unless otherwise mentioned. Furthermore, the terminology and phraseology used herein is solely used for descriptive purposes and should not be construed as limiting in scope. Language such as “including,” “comprising,” “having,” “containing,” or “involving,” and variations thereof, is intended to be broad and encompass the subject matter listed thereafter, equivalents, and additional subject matter not recited, and is not intended to exclude other additives, components, integers or steps. Likewise, the term “comprising” is considered synonymous with the terms “including” or “containing” for applicable legal purposes. Any discussion of documents, acts, materials, devices, articles and the like are included in the specification solely for the purpose of providing a context for the present invention. It is not suggested or represented that any or all of these matters form part of the prior art base or were common general knowledge in the field relevant to the present invention.

In this disclosure, whenever a composition or an element or a group of elements is preceded with the transitional phrase “comprising”, it is understood that we also contemplate the same composition, element or group of elements with transitional phrases “consisting of”, “consisting”, “selected from the group of consisting of, “including”, or “is” preceding the recitation of the composition, element or group of elements and vice versa.

The present invention is described hereinafter by various embodiments with reference to the accompanying drawing, wherein reference numerals used in the accompanying drawing correspond to the like elements throughout the description. This invention may, however, be embodied in many different forms and should not be construed as limited to the embodiment set forth herein. Rather, the embodiment is provided so that this disclosure will be thorough and complete and will fully convey the scope of the invention to those skilled in the art. In the following detailed description, numeric values and ranges are provided for various aspects of the implementations described. These values and ranges are to be treated as examples only and are not intended to limit the scope of the claims. In addition, a number of materials are identified as suitable for various facets of the implementations. These materials are to be treated as exemplary and are not intended to limit the scope of the invention.

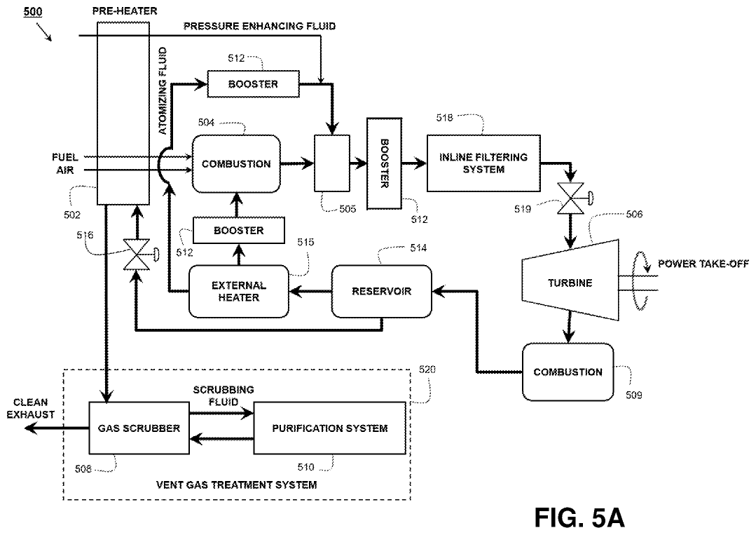

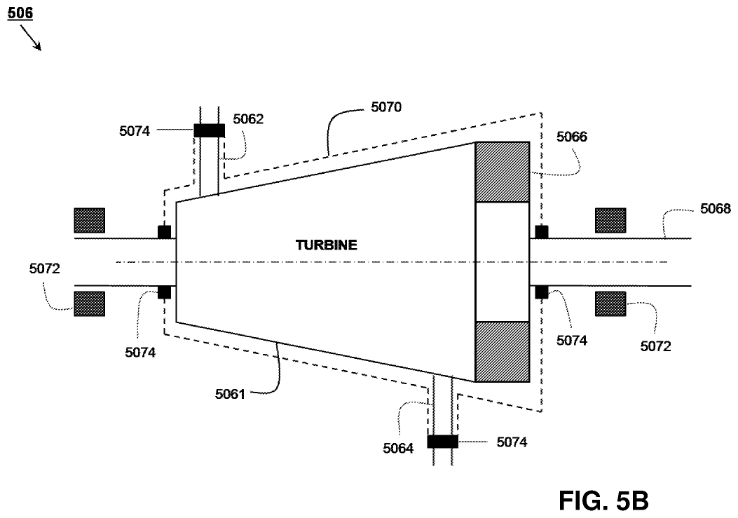

Referring to the drawings, the invention will now be described in more detail. FIG. 5A illustrates a system (500) for power generation in accordance with an embodiment of the present invention. As shown in FIG. 5A, the system (500) comprises a pre-heater (502) connected with a combustion chamber (504). The pre-heater (502) is used to pre-heat the air and/or fuel entering into the combustion chamber (504). The pre-heating of the air increases a thermal efficiency of the combustion process which is orchestrated in the combustion chamber (504). In various embodiments, the design of the combustion chamber (504) depends upon a number of factors, including, but not limited to, type of fuel (for example solid, liquid or gaseous) and working fluid being used in the system (500). For example, the design of the combustion chamber (504) may vary depending upon whether air is the working fluid or air-steam mixture or mixture of air with some other fluid such as ammonia etc. is the working fluid. There may be other variations in the design of the combustion chamber (504) depending upon the specific requirements of the system (500). For example, another factor in deciding a design of the combustion chamber (504) may be operating conditions and how or how many times firing is being achieved. In various embodiments, the combustion chamber (504) is one of a single stage combustion chamber (504) or a multi-stage combustion chamber (504).

It will be appreciated by a person skilled in the art that the air being supplied to the combustion chamber (504) may be replaced with oxygen enriched air or pure oxygen. It is further contemplated that in various embodiments, an inline filtering system (518) may also be provided inside or downstream of the combustion chamber (504) to remove any particulate matters from combustion products. This is highly desirable, especially in cases where air is the working fluid and/or coal is used as the fuel.

Further, connected downstream of the combustion chamber (504) is a turbine unit (506). In various embodiments, the turbine unit (506) is selected from a group consisting of single stage turbine units and multi-stage turbine units. The design of the turbine unit (506) may also vary depending upon a type of application for the system (500) or a type of the working fluid being used. There may be several other factors that may account for selection of the turbine unit (506) as will be appreciated by a person skilled in the art.

FIG. 5B illustrates the turbine unit (506) in accordance with an embodiment of the present invention. As shown in FIG. 5B, the turbine unit (506) has a rotor assembly (5061), a turbine unit inlet (5062) adapted to receive the working fluid and a turbine unit outlet (5064) adapted to discharge the working fluid. Further, the turbine unit (506) is contemplated to have an energy storage mechanism (5066) adapted to store mechanical energy during operation of the turbine unit (506). The energy storage mechanism (5066) utilizes an inherent moment of inertia achieved through its design, to store the mechanical energy. In accordance with an embodiment, the energy storage mechanism (5066) is constituted by a flywheel attached at a Power Take-Off (PTO) shaft (5068) of the turbine unit (506). It is further contemplated here that design of the flywheel is based on capacity of the system (500). Also, the PTO shaft (5068) may further be provided with a plurality of bearings (5072), such as magnetic bearings or air bearings or any other such setup that may help to reduce frictional losses. In another embodiment, the energy storage mechanism (5066) includes a number of masses placed radially outwards of the PTO shaft (5068).

The mechanical/kinetic energy stored by the energy storage mechanism may be harnessed by another external system to generate useful power. Such an external system may be one of, but not limited to, an electrical power generation system, a propulsion system for a vehicle such as a car, a submarine or an aeroplane, and an industrial system relying on mechanical power, such as an industrial pump or a compressor. The turbine unit outlet (5064) is further connected with the pre-heater (502) and the combustion chamber (504).

The combustion chamber (504) is connected upstream of the turbine unit inlet (5062) and the turbine unit outlet (5064) is connected upstream of the combustion chamber (504) and the pre-heater (502). In this manner, the combustion chamber (504), the turbine unit inlet (5062) and the turbine unit outlet (5064) together form a closed loop for the working fluid to operate in. It is envisaged that all the piping and equipment used in formation of the closed loop is insulated to prevent any heat transfer. Further, wherever needed the piping and the equipment is also envisaged to include cooling systems to maintain operating temperatures. In the context of the specification, the word “piping” is envisaged to include all kinds of conduits required for circulation of fluids at predetermined temperatures, pressures and velocity. For example, for fluids at relatively lower temperatures but higher pressures and velocities, the piping could be made up of a metal. For fluid at relatively higher temperatures and velocities, but lower pressures, the piping may be construed either as metallic piping with refractory lining or ducting made up of a refractory material or combinations of the above are also possible. A skilled addressee would appreciate that many other variations for the piping are possible without departing from the scope of the invention.

In various embodiments, re Further, in order to ensure that the vacuum is maintained inside the rotor housing (5070), additional sealing means (5074) may be provided wherever there is a possibility of leakage. For example, between the PTO shaft (5068) and the rotor housing (5070), between turbine unit inlet (5062) and the rotor housing (5070) and between the rotor housing (5070) and the turbine unit outlet (5064).

Returning to FIG. 5A and subsequent discussion, in various embodiments, a regulator (505) has been located in the closed loop. It will be appreciated by a person skilled in the art that the regulator (505) may be located at any location in the closed loop, and between any two pieces of equipment, such as, between the combustion chamber (504) and the inline filtering system (518) or between a booster (512) and the combustion chamber (504). The booster (512) may be for example a blower or a compressor. The regulator (505) is configured to regulate pressure, temperature, velocity and mass flow rate of the working fluid operating in the system (500).

In several embodiments, there is further connected a reservoir (514) to the turbine unit outlet (5064), between the turbine unit outlet (5064), and, the combustion chamber (504) and the pre-heater (502). The reservoir (514) is configured to receive the working fluid from the closed loop and release excess working fluid to the atmosphere, through the pre-heater (502). The release of the excess working fluid may be facilitated by a control valve (516). The control valve (516) is configured to automatically open when a pressure inside the reservoir (514) exceeds a predetermined value. The pre-heater (502) is configured to pre-heat the air and the fuel entering into the combustion chamber (504), using heat of the working fluid released by the reservoir (514), or released by the turbine unit outlet (5064), in absence of the reservoir (514).

There may be added a second combustion chamber (509) at the turbine unit outlet (5064). The purpose of the second combustion chamber (509) at the turbine outlet (5064) is to enhance velocity of the working fluid going out of the turbine outlet (5064). Further, downstream of the reservoir (514), there may be located an external heater (515). The external heater (515) is configured to heat the working fluid using a heat exchanger. The heating of the working fluid in the heat exchanger may be achieved through flue gases generated by an external combuster (902).

Further connected with the pre-heater (502) is a vent gas treatment system (520), having a gas scrubber (508) and a purification system (510). The gas scrubber (508) is a pollution control device configured to remove harmful and undesirable pollutants that might be present in the working fluid coming out of the turbine unit outlet (5064) or the pre-heater (502). The design of the gas scrubber (508) may vary depending upon the type and/or composition of the working fluid. For example, different scrubbers may be used for different working fluids such as air, air and steam mixture, air and ammonia mixture etc. or potential pollutants such as Oxides of Nitrogen (NOx), Sulphur Dioxide (SO₂), Carbon Dioxide (CO₂) or Water, as will be appreciated by a person skilled in the art. The gas scrubber (508) employs one or more scrubbing fluids to achieve scrubbing of the working fluid. One example of the scrubbing fluid is water.

The gas scrubber (508) is further connected with the purification system (510) configured to purify the one or more scrubbing fluids, after the use of the scrubbing fluids in the gas scrubber (508). The purified scrubbing fluids may in turn be used for various purposes inside the system (500). In various embodiments, the purification system (510) is in turn connected with the combustion chamber (504), feeding scrubbing fluid (more specifically water) to the combustion chamber (504) in case of air-steam mixture being the working fluid.

It is further contemplated here that the system (500) may constitute an industrial plant and may be provided with other equipment essential for running of the industrial plant. Such equipment includes, but is not limited to, control devices such as enterprise servers, plant servers, PLC controllers, input/output devices and field devices such as sensors (pressure, temperature, speed etc), actuators (motors, pumps and valves etc.) and the like. These and other equipment may operate under supervision of an operator or automatically to aid in achieving objectives of this invention. Process controls are also achievable vide embedded systems of sensors and actuators controlled remotely and/or locally enabling advance services and support Internet of Things (IoT) and Distributed Control System (DCS) and any other enabling technology which can be contemplated to be applicable for this invention, existing at the date of filing or appearing in foreseeable future.

All piping and other equipment handling hot flue gases and combustion equipments will be suitably insulated and wherever the need is, a cooling system may be employed.

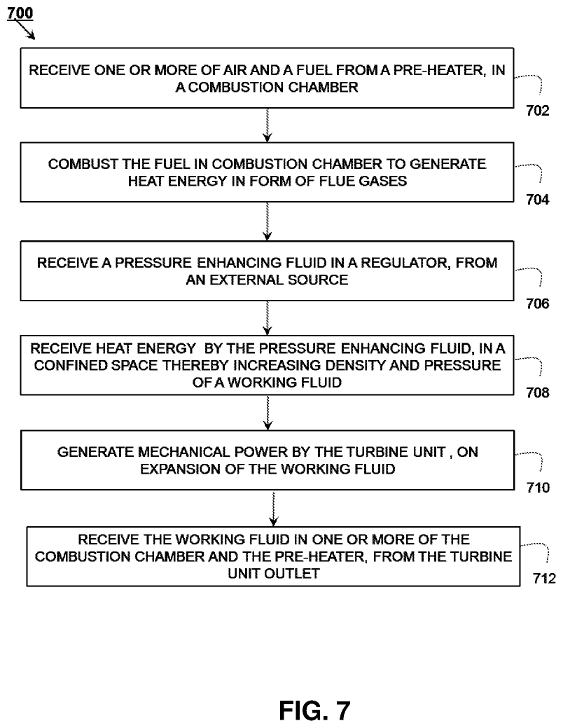

FIG. 7 illustrates a method (700) for power generation in accordance with an embodiment of the present invention. The method (700) begins at step (702) when one or more of air and a fuel are received from the pre-heater (502), inside the combustion chamber (504). In case of the fuel being one of liquid and gaseous fuels, both the air and the fuel are received in the combustion chamber (504), from the pre-heater (502). In case of the fuel being a solid fuel, only air is received from the pre-heater (502). Here, the term ‘air’ represents one or more of air, oxygen enriched air and pure oxygen. Further, in various embodiments, the fuel is selected from a group consisting of solid, semi-solid, liquid and gaseous fuels, such as but not limited to, coal, charcoal, coal water slurry, wood, petroleum products, natural gas and biomass etc.

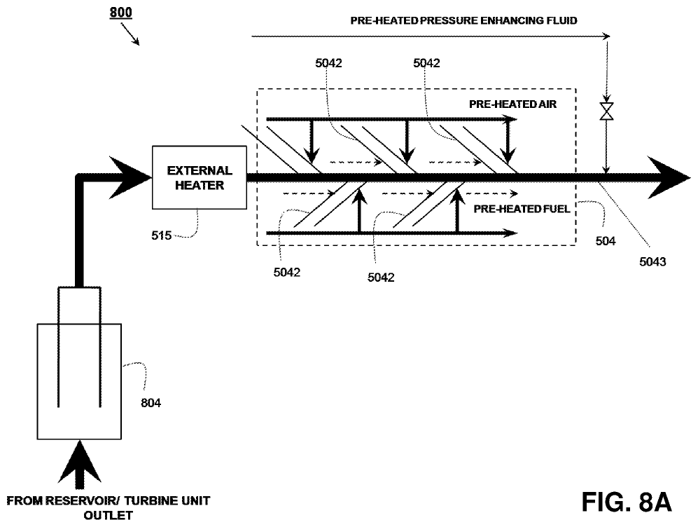

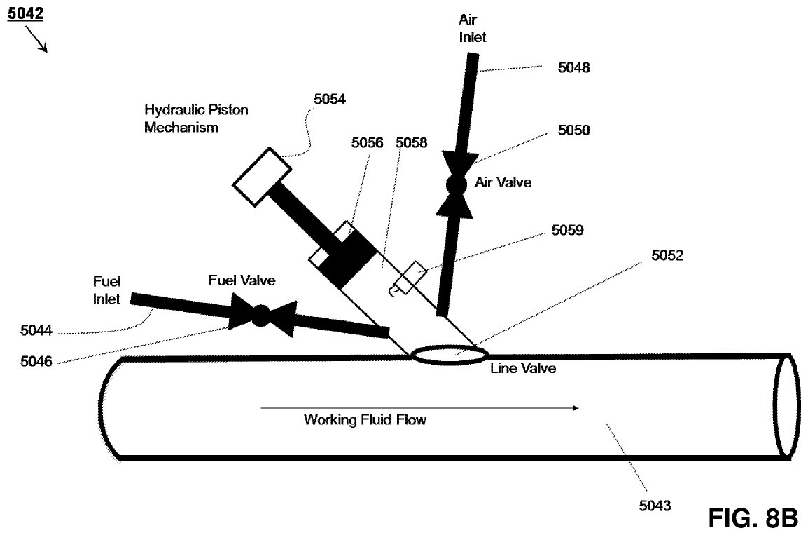

At step (704), the fuel is combusted in the combustion chamber (504) to generate heat energy in form of flue gases. FIG. 8A illustrates a combustion chamber (504) in accordance with an embodiment of the present invention. The combustion chamber (504) comprises a plurality of pulse combusters (5042). FIG. 8B illustrates a pulse combuster (5042) in accordance with an embodiment of the present invention. The pulse combuster (5042), inter alia, is contemplated to have a hydraulic piston mechanism (5054), adapted to push the generated flue gases completely into the working fluid flow, using a piston (5056). This enables the flue gases to be pressurized to a much higher value than pressure of the working fluid flow. Alternately, solid fuel may be fired in the combustion chamber (504).

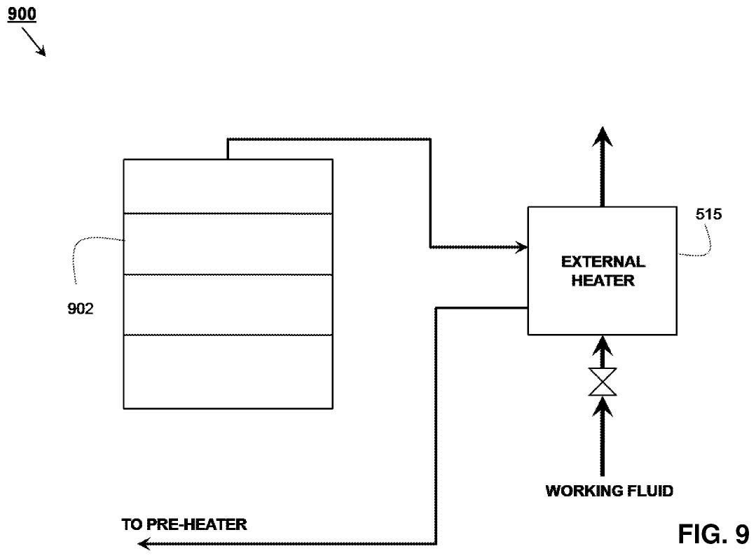

FIG. 9 illustrates an implementation of the present invention for external combustion and indirect heat application. Here an external combuster (902) combusts a solid fuel and generates flue gases. The flue gases generated by the external combuster (902) are used in the external heater (515) to transfer heat to the working fluid.

At step (706), a pressure enhancing fluid is received in the regulator (505), from an external source. During receiving of the pressure enhancing fluid, a booster (512) increases a pressure of a portion of the working fluid being used as an atomizing fluid. The increased pressure of the atomizing fluid causes the pressure enhancing fluid to be atomized into small droplets, thereby increasing a net surface area. The increased net surface area causes faster heat transfer between the flue gases and the pressure enhancing fluid for vaporization of the droplets, inside the regulator (505). In accordance with an embodiment, the external source is a reservoir for collecting the pressure enhancing fluid, such as a reservoir of liquefied Carbon-di-Oxide (CO₂) or a tank for holding de-mineralized water. In various other embodiments, the external source is the purification system (510) feeding treated water to the regulator (505). In several embodiments, the pressure enhancing fluid is pre-heated in the pre-heater (502) and atomized using a portion of the working fluid obtained from the external heater (515), at the time of introduction into the regulator (505).

In various embodiments, the pressure enhancing fluid is a phase change fluid, supplied to the regulator (505) in liquefied form. Further, the pressure enhancing fluid absorbs the heat energy generated during combustion, to change from liquid phase to gaseous phase. It is further contemplated here, that to aid faster phase transformation of the pressure enhancing fluid, the pressure enhancing fluid is supplied to the regulator (505) at a high temperature. A mixture of the pressure enhancing fluid and flue gases generated due to combustion, constitute a working fluid for the purpose of the present invention.

At step (708), the heat energy is received by the pressure enhancing fluid in a confined space thereby increasing density and pressure of the working fluid. The increased pressure and density of the working fluid can be used to increase mass and velocity of the working fluid to generate power.

At step (710), mechanical power is generated by the turbine unit (506), on expansion of the working fluid. It is contemplated here that working fluid is delivered a sufficiently high velocity and pressure onto blades of the turbine unit (506). In one embodiment, the working fluid coming out of the combustion chamber (504) is expanded at the turbine unit inlet (5062) to increase velocity of the working fluid to a predetermined level. In another embodiment, velocity enhancement means may be installed at an outlet of the combustion chamber (504), to increase the velocity of the working fluid to the predetermined level.

In various embodiments, the energy storage mechanism (5066) is arranged to operate at a plurality of levels of speed of rotation of the PTO shaft (5068) and firing in the combustion chamber (504) may be adjusted as a function of the plurality of levels. A typical speed range would be 10000 to 20000 rpm. For example, at a rated speed of the PTO shaft (5068), the firing in the combustion chamber (504) may be completely terminated, by for example a PLC controller located inside the system (500). It is further contemplated that the speed of the PTO shaft (5068) may be sensed by a speed sensor and communicated to the control device through a network established within the system (500). At a lower speed of the PTO shaft (5068), the firing inside the combustion chamber (504) may be initiated in order to regain a higher speed and to meet a power demand.

The operation of the energy storage mechanism (5066) at the plurality of speeds of rotation allows intermittent firing. The storage of the mechanical energy in energy storage mechanism (5066) also helps in catering fluctuations in power demands, in case the PTO shaft (5068) has been coupled to an electrical power generation system. Intermittent firing results in lesser costs and simpler design systems for cooling the heated components of the system, making the system even more efficient.

During generation of the electricity and non-firing of the combustion chamber (504), speed of the energy storage mechanism (5066) will gradually drop to a lower value as compared to a design speed. This speed can be brought to a predetermined speed value by again firing the combustion chamber (504). Additionally, it is contemplated here, that the speed of rotation of the energy storage mechanism (5066) is kept sufficiently high in order to ensure that potential power availability in the energy storage mechanism (5066) is always higher than the requirements of the electricity generation subsystems (alternators/generators, power electronics etc.).

It will be appreciated by a person skilled in the art that other equipment such as Variable Speed Drives and fixed speed drives with speed governors may be employed as per the demands of the electricity generation subsystems. This may allow the turbine unit (506) to run at variable speeds without affecting the performance of electricity generation subsystems.

Further, the power generated by the system (100) can be correlated with the plurality of speeds of rotation. A unique value of power may be obtained at any one speed of rotation of the PTO shaft (5068) as mechanical energy stored in the energy storage mechanism is a function of the speed of the rotation. This will further help in planning operation of other components of the system (100). Intermittent firing also allows the turbine unit (506) to be operated inside number of turndown ratios. A typical range of turndown ratios would be 0% to 150%. Additionally, variable reduction gearbox may be deployed along the PTO shaft (5068) to enable operation of low speed machinery such as a low speed generator.

Combustion parameters and fuel requirements can be planned for the combustion chamber (504). Opening pressure can be selected for the control valve (516). Since speed of the turbine unit (506) can be increased substantially by pressurizing the working fluid or by increasing velocity of the working fluid, need for a gearbox between the turbine unit (504) and a generator for electrical power generation can be eliminated. Further, need for maintaining fixed speeds of the turbine unit (506) is eliminated due to presence of the energy storage mechanism (5066). Additionally, fluctuations in temperature, pressure and velocity of the working fluid does not affect the power output. Further, higher voltages as per grid requirements can be achieved in case of electrical power generation. Further, control over variable power as per grid requirements in real time basis can be achieved. Further working fluid is discharged out of the turbine unit outlet (5064), after the expansion of the working fluid, by the turbine unit (506).

At step (712) the working fluid is received in one or more of the combustion chamber (504) and the pre-heater (502), from the turbine unit outlet (5064). In various embodiments an additional booster (512) may be deployed to transfer the working fluid from the reservoir (514) to the combustion chamber (504). Additionally, the booster (512) may be deployed to enhance pressure, velocity and temperature of the working fluid. It is contemplated here, that the capacity of the booster (512) (especially pressure at outlet of the booster (512)) is higher than the pressures experienced by the working fluid in the system (500).

However, in case fresh supply of heated working fluid is added to the closed loop, from the combustion chamber (504), equivalent mass of the working fluid is discharged to the atmosphere, through the pre-heater (502). This is to maintain physical parameters, such as pressure, velocity and mass flow rate etc. in the closed loop. The combustion chamber (504) is designed to re-energize the working fluid to attain a predetermined quality.

In various embodiments, the equivalent mass of the working fluid is discharged from the reservoir (514), due to opening of the control valve (516). As additional mass of the fresh supply of the working fluid is added to the closed loop, a total pressure in the closed loop is increased above a predetermined system pressure, based on the application of the system (500). This makes the control valve (516) to open in order to bring the total pressure in the closed loop to the predetermined system pressure.

In various other embodiments, the equivalent mass can be predetermined based on system parameters, and the control valve (516) may be operated automatically to release the equivalent mass as per predetermined schemes. For example, the equivalent mass can be discharged for every cycle, or between a number of cycles or intermittently as per the design requirements of the invention.

In the pre-heater (502), the discharged working fluid pre-heats the fuel and the air being supplied to the combustion chamber. The working fluid is then transferred from the pre-heater (502) to the gas scrubber (508), where the scrubbing fluid scrubs the working fluid to remove any harmful matter from the working fluid. The working fluid is then discharged to the atmosphere through the purification system (510), and the purified scrubbing fluid (typically water) may be re-used in the system (500). In case of the air-ammonia mixture or air-steam mixture being the working fluid, some mass may be added inside the combustion chamber (504). This added mass may be removed through a receiver (not shown), in order to balance a total mass of the working fluid in the system (500). It is further contemplated, that the removed mass may be cooled in a heat exchanger and treated to remove hazardous emissions before being vented out to the atmosphere.

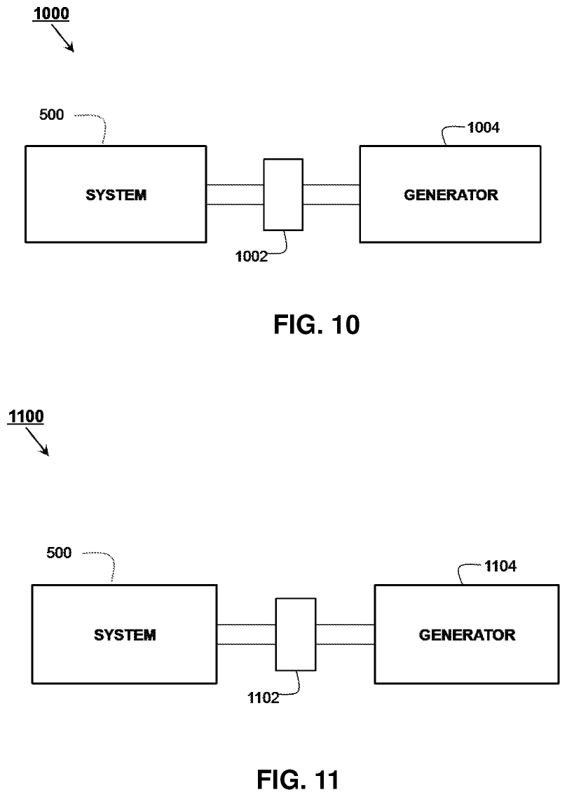

FIG. 10 illustrates implementation of the system (500) for electrical power generation, in accordance with an embodiment 1000 of the present invention. As can be seen from FIG. 10, the system (500) is coupled to a generator (1004) using a coupling (1002). The advantage of this setup is that fixed speed reduction gear box is not required to run the generator (1004). The speed of the generator (1004) can be controlled using variable speed gearbox and intermittent firing of the combustion chamber (504). Further, the energy storage mechanism (5066) will always have higher levels of potential energy compared to the electricity being generated.

FIG. 11 illustrates implementation of the system (500) electrical power generation, in accordance with another embodiment (1100) of the present invention. The system (500) is coupled to a generator (1104) using a coupling (1102). The system (500) here is operated at a fixed speed.

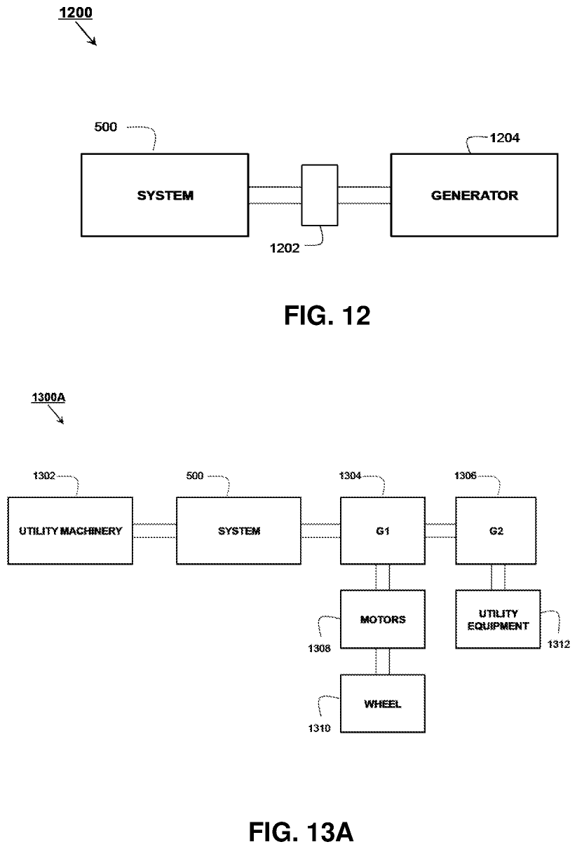

FIG. 12 illustrates implementation of the system (500) for electrical power generation, in accordance with another embodiment 1200 of the present invention.

In relation to FIGS. 10, 11 and 12, the present invention can be used for electrical power generation where the rotational energy is main driving mechanism of alternator, for e.g. provided by Turbines (Gas and Steam), IC engines etc. The present invention does not require pressure enhancing equipment like air-compressor and steam boiler, therefore utility energy requirement of this technology reduces drastically. The present invention enhances velocity, pressure and temperature by means of the pressure enhancing fluid added through the regulator (505) located in the closed loop.

Electricity is generated by coupling the rotational energy of the turbine unit (506) to a generator/alternator. The present invention is capable of generating electricity without fluctuations with the help of flywheel and frictionless systems. Stator/rotor assembly is coupled with the turbine (506) through power electronics systems, while power is supplied by the energy storage mechanism (5066) during non-operation of the combustion chamber (504). This allows intermittent firing of the combustion chamber (504).

Step-up or step-down mechanism is not required in this technology which eliminates related losses. The required speed to get desire quality power is achieved with the help of flywheels, variable speed gear systems and power electronics.

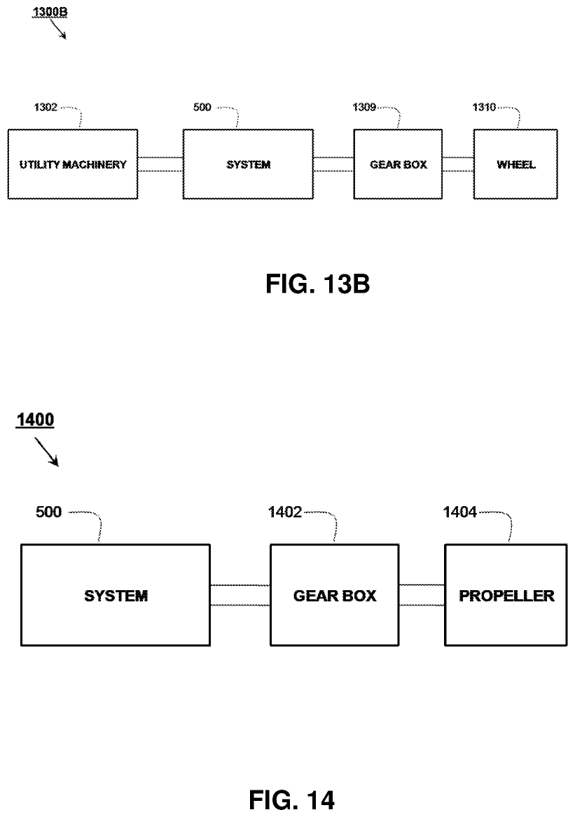

FIG. 13A illustrates implementation of the system (500) for propulsion of locomotives, in accordance with an embodiment (1300A) of the present invention. The PTO shaft (5068) of the system (500) is used to operate utility machinery (1302) and a generator (1304). The generator (1304) is used to power motors (1308) which are in turn used to run wheels (1310) of the locomotive. Further, the generator (1304) is used to run utility equipment such as Air Conditioners and lighting etc.

FIG. 13B illustrates implementation of the system (500) for propulsion of locomotives, in accordance with another embodiment 1300B of the present invention. Here, the system (500) is being used to power the utility machinery (1302) and the wheels (1310) directly through the gearbox (1309).

FIG. 14 illustrates implementation of the system (500) for propulsion of marine vessels, in accordance with an embodiment (1400) of the present invention. The system (500) is being used to run propeller (1404) of the marine vessel.

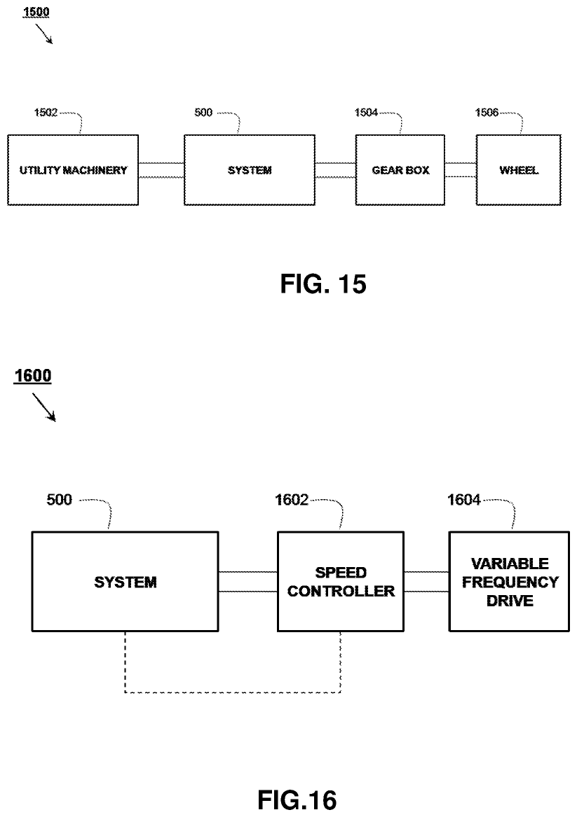

FIG. 15 illustrates implementation of the system (500) in off-road vehicles, in accordance with an embodiment of the present invention. There can be various types of off-road vehicles, such as those being used in earth moving, road construction and agricultural activities such as harvesting. Here the system (500) is being used to run utility machinery (1502), such as hydraulics. Further, the system (500) is being used to run the wheels (1506) using the gear box (1504).

FIG. 16 illustrates implementation of the system (500) for operation of industrial equipment, in accordance with an embodiment (1600) of the present invention. Different types of industrial equipment include, but are not limited to compressor, pumps, mixer, cutters, hammer mill, pulverize, ball mills, food processing machines, special purpose machine and conveyers. Here, the system (500) is connected with a speed controller (1602). The speed controller (1602) is further configured to a variable frequency drive (1604).

In relation to FIGS. 13A to 16, the present invention is a potential replacement for all IC engines, micro-turbines, gas turbines, steam turbines etc. to get rotational energy which will be used for automobile equipment's, ship engines, railway engines, compressors, pumps, and any other rotating machines which required rotational mechanical energy.

Automobiles operate on mechanically driven, battery operated and hybrid designs that are possible to be replaced with this technology. The battery requirement in electric and hybrid design of automobiles is eliminated and its electric motors are operated on power generated through specially designed alternator connected to turbine shaft. Here the energy storage mechanism (5066) acts to store power being generated by the turbine unit (506). Automobiles operated on mechanical transmission systems like cars, trucks, earth moving equipment's etc. can be directly connected to the system (500) by using, for example, gimbal bearing and gyroscopic arrangements. Also, some add-ons can be provided which will support to operate the automotive utility equipment's like Hydraulics, AC, air compressor etc.

The efficient combustion system of this technology which operates on any type of fuels including coal slurry will reduce the hazardous emissions. The losses occur in the form of heat, vibrations and sound are minimised in this technology

Various modifications to these embodiments are apparent to those skilled in the art from the description. The principles associated with the various embodiments described herein may be applied to other embodiments. Therefore, the description is not intended to be limited to the embodiments but is to be providing broadest scope consistent with the principles and the novel and inventive features disclosed or suggested herein. Accordingly, the invention is anticipated to hold on to all other such alternatives, modifications, and variations that fall within the scope of the present invention.

1. A system for power generation, the system comprising:
a combustion chamber connected upstream of a turbine unit inlet of a turbine unit;
a turbine unit outlet of the turbine unit connected upstream of the combustion chamber and a pre-heater, the combustion chamber, the turbine unit inlet and the turbine unit outlet forming a closed loop for a working fluid to operate in; and
a regulator connected within the closed loop;
wherein the combustion chamber is configured to receive one or more of air and a fuel from a pre-heater and combust the fuel to generate heat energy in form of flue gases;
wherein the regulator is configured to receive a pressure enhancing fluid, from an external source, a mixture of the pressure enhancing fluid and the flue gases generated due to combustion, constituting the working fluid, such that, the pressure enhancing fluid receives heat energy from the flue gases to vaporize in a confined space, thereby increasing density and pressure of the working fluid; wherein the turbine unit is configured to generate mechanical power on expansion of the working fluid and discharge the working fluid out of the turbine unit outlet, after the expansion of the working fluid; and
wherein the combustion chamber and the pre-heater are configured to receive the working fluid from the turbine unit outlet.

2. The system as claimed in claim 1, wherein the fuel is one or more of a gaseous fuel, a liquid fuel, a semi-solid fuel and a solid fuel.

3. The system as claimed in claim 1, wherein the regulator is configured to receive the pressure enhancing fluid in pre-heated state and liquid phase.

4. The system as claimed in claim 1, further comprising a speed sensor configured to sense a speed of a Power Take-Off (PTO) shaft of the turbine unit and communicate the speed to a control device configured to control intermittent firing in the combustion chamber in correlation with the speed.

5. The system as claimed in claim 1, wherein an energy storage system of the turbine unit is configured to supply power during non-operation of the combustion chamber.

6. The system as claimed in claim 1, wherein the regulator is further configured to regulate pressure, temperature, velocity and mass flow rate of the working fluid.

7. The system as claimed in claim 1, further comprising a reservoir downstream of the turbine unit wherein the reservoir is configured to receive the working fluid from the closed loop and release excess working fluid to the atmosphere.

8. The system as claimed in claim 1, further comprising an external heater connected along the closed loop, wherein the external heater is configured to heat the working fluid using a heat exchanger, the heating of the working fluid in the heat exchanger being achieved through flue gases generated by an external combuster.

9. The system as claimed in claim 1, wherein a piping and equipment used in formation of the closed loop is insulated to prevent heat transfer and the piping and the equipment also include cooling systems to maintain operating temperatures.

10. The system as claimed in claim 1, further comprising an energy storage mechanism, the energy storage mechanism including a flywheel connected to a power take-off shaft of the turbine unit.

11. The system as claimed in claim 11, wherein the energy storage mechanism is adapted to store mechanical energy during operation of the turbine unit.

12. The system as claimed in claim 1, further comprising a second combustion chamber at the turbine unit outlet, the second combustion chamber configured to enhance velocity of the working fluid going out of the turbine unit outlet.

13. The system as claimed in claim 1, further comprising one or more boosters along the closed loop, the one or more boosters is configured to enhance pressure, velocity and temperature of the working fluid.

14. The system as claimed in claim 1, wherein the combustion chamber further comprises a plurality of pulse combustors.

15. The system as claimed in claim 14, wherein each one of the plurality of pulse combustors comprises a hydraulic piston mechanism, wherein a piston of the hydraulic piston mechanism is adapted to push the flue gases into a working fluid flow in order to increase the temperature and the pressure of the working fluid flow.

16. A pulse combustor comprising a hydraulic piston mechanism, wherein a piston of the hydraulic piston mechanism is adapted to push flue gases into a working fluid flow in order to increase the temperature and the pressure of the working fluid flow.

17. A method for power generation comprising:
receiving one or more of air and a fuel from a pre-heater in a combustion chamber;
combusting the fuel to generate heat energy in form of flue gases;
receiving a pressure enhancing fluid, from an external source, in a regulator, a mixture of the pressure enhancing fluid and the flue gases generated due to combustion, constituting a working fluid,
receiving heat energy by the pressure enhancing fluid from the flue gases, to vaporize in a confined space, thereby increasing density and pressure of the working fluid;
generating mechanical power on expansion of the working fluid and discharging the working fluid out of a turbine unit outlet, after the expansion of the working fluid, by a turbine unit; and
receiving the working fluid from the turbine unit outlet in one or more of the combustion chamber and the pre-heater.

18. The method as claimed in claim 17, wherein the temperature of the working fluid is more than 200° C.

19. The method as claimed in claim 17, wherein the regulator receives the pressure enhancing fluid in a pre-heated state and liquid phase.

20. The method as claimed in claim 17, further comprising a step of sensing a speed of a Power Take-Off (PTO) shaft of the turbine unit and communicating the speed to a control device to control intermittent firing in the combustion chamber in correlation with the speed.

21. The method as claimed in claim 17, further comprising a step of supplying power, by an energy storage system of the turbine unit, during non-operation of the combustion chamber.

22. The method as claimed in claim 17, wherein the regulator further regulates pressure, temperature, velocity and mass flow rate of the working fluid.

23. The method as claimed in claim 17, further comprising a step of receiving the working fluid from a closed loop and releasing excess working fluid to the atmosphere, by a reservoir downstream of the turbine unit.

24. The method as claimed in claim 17, further comprising a step of heating the working fluid using a heat exchanger of an external heater connected along a closed loop, the heating of the working fluid in the heat exchanger being achieved through flue gases generated by an external combuster.

25. The method as claimed in claim 17, further comprising a step of storing mechanical energy during operation of the turbine unit by an energy storage mechanism.

26. The method as claimed in claim 17, further comprising a step of enhancing velocity of the working fluid going out of the turbine unit outlet, by a second combustion chamber at the turbine unit outlet.

27. The method as claimed in claim 17, further comprising a step of enhancing pressure, velocity and temperature of the working fluid, by one or more boosters along a closed loop.

28. The method claimed in claim 17, further comprising a step of pushing the flue gases into a working fluid flow to increase the temperature and the pressure of the working fluid flow, by a hydraulic piston mechanism of a plurality of pulse combustors.
